(19) United States
(12) Patent Application Publication
(10) Pub. No.: US 2026/0004201 A1
(43) Pub. Date: Jan. 1, 2026

(54) RANDOM FOREST OPTIMIZATION METHOD AND SYSTEM THEREOF AND COMPUTER READABLE RECORDING MEDIUM

(71) Applicant: NATIONAL TSING HUA UNIVERSITY, HSINCHU (TW)

(72) Inventor: Wei-Chang YEH, Hsinchu (TW)

(21) Appl. No.: 19/001,533

(22) Filed: Dec. 25, 2024

(30) Foreign Application Priority Data
Jun. 28, 2024 (TW) 113124176

(51) Int. Cl. G06N 20/20

(52) U.S. Cl. CPC G06N 20/20

(57) ABSTRACT

A random forest optimization method includes driving a processor to generate a setting value group according to a Simplification Swarm Optimization rule; driving the processor to transform the setting value group into a plurality of decision tree codes and a plurality of weight values corresponding to the decision tree codes of a random forest model, the decision tree codes correspond to a plurality of binary decision tree models; driving the processor to calculate an accuracy and a decision tree number corresponding to the setting value group; driving the processor to update a best accuracy and a lowest decision tree number in a database according to the accuracy and the decision tree number of the setting value group; driving the processor to repeating the above steps until a number of a plurality of the setting value groups being equal to a predetermined value.

### RELATED APPLICATIONS

This application claims priority to Taiwan Application Serial Number 113124176, filed Jun. 28, 2024, which is herein incorporated by reference.

### BACKGROUND

### Technical Field

The present disclosure relates to an optimization method, a system thereof and a computer readable recording medium. More particularly, the present disclosure relates to a random forest optimization method, a system thereof and a computer readable recording medium.

### Description of Related Art

A random forest model includes a plurality of decision trees, and the training dataset and the features are trained via random subset. When a testing dataset is inputted to the random forest model, all the decision trees in the random forest model generate predicting results, and a final predicting result is determined via Majority Vote to reduce variance and overfitting. Further, the random forest model fine-tunes the important branches, the number of the decision trees and the maximum depth of the decision trees by hyper parameters.

In the random forest model, although an accuracy of the model is positively related to the number of the decision trees, the number of the decision trees is also positively related to a calculating complexity of the model. Furthermore, as the number of the decision trees increases, the probability of overfitting also increases.

Therefore, a random forest optimization method, a system thereof and a computer readable recording medium which can increase the predicting accuracy and reduce the calculating complexity at the same time are commercially desirable.

### SUMMARY

According to one aspect of the present disclosure, a random forest optimization method includes driving a processor to generate a setting value group according to a Simplification Swarm Optimization rule; driving the processor to transform the setting value group into a plurality of decision tree codes and a plurality of weight values corresponding to the decision tree codes of a random forest model, the decision tree codes correspond to a plurality of binary decision tree models; driving the processor to calculate an accuracy and a decision tree number corresponding to the setting value group, the accuracy is a predicting accuracy of the random forest model, and the decision tree number is a number of the binary decision tree models; driving the processor to update a best accuracy and a lowest decision tree number in a database according to the accuracy and the decision tree number of the setting value group; driving the processor to repeating the above steps until a number of a plurality of the setting value groups being equal to a predetermined value.

According to another aspect of the present disclosure, a random forest optimization system includes a database and a processor. The database includes a Simplification Swarm Optimization rule, a random forest model, a best accuracy and a lowest decision tree number. The processor is signally connected to the database, and configured to perform a random forest optimization method. The random forest optimization method includes generating a setting value group according to the Simplification Swarm Optimization rule; transforming the setting value group into a plurality of decision tree codes and a plurality of weight values corresponding to the decision tree codes of the random forest model, the decision tree codes correspond to a plurality of binary decision tree models; calculating an accuracy and a decision tree number corresponding to the setting value group, the accuracy is a predicting accuracy of the random forest model, and the decision tree number is a number of the binary decision tree models; updating the best accuracy and the lowest decision tree number according to the accuracy and the decision tree number of the setting value group; repeating the above steps until a number of a plurality of the setting value groups being equal to a predetermined value.

According to further another aspect of the present disclosure, a computer readable recording medium storing a program for a processor to execute a random forest optimization method. The random forest optimization method includes driving the processor to generate a setting value group according to a Simplification Swarm Optimization rule; driving the processor to transform the setting value group into a plurality of decision tree codes and a plurality of weight values corresponding to the decision tree codes of a random forest model, the decision tree codes correspond to a plurality of binary decision tree models; driving the processor to calculate an accuracy and a decision tree number corresponding to the setting value group, the accuracy is a predicting accuracy of the random forest model, and the decision tree number is a number of the binary decision tree models; driving the processor to update a best accuracy and a lowest decision tree number in a database according to the accuracy and the decision tree number of the setting value group; driving the processor to repeating the above steps until a number of a plurality of the setting value groups being equal to a predetermined value.

### BRIEF DESCRIPTION OF THE DRAWINGS

The present disclosure can be more fully understood by reading the following detailed description of the embodiment, with reference made to the accompanying drawings as follows:

FIG. 1 shows a flow chart of a random forest optimization method according to a first embodiment of the present disclosure.

FIG. 2 shows a block diagram of a random forest optimization system according to a second embodiment of the present disclosure.

FIG. 3 shows a schematic view of updating the best accuracy and the lowest decision tree number of the random forest optimization method of FIG. 1.

FIG. 4 shows a comparative schematic view between the decision tree number of the random forest optimization method of FIG. 1 and a decision tree number of a conventional Optuna method.

FIG. 5 shows a flow chart of a random forest optimization method according to a third embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

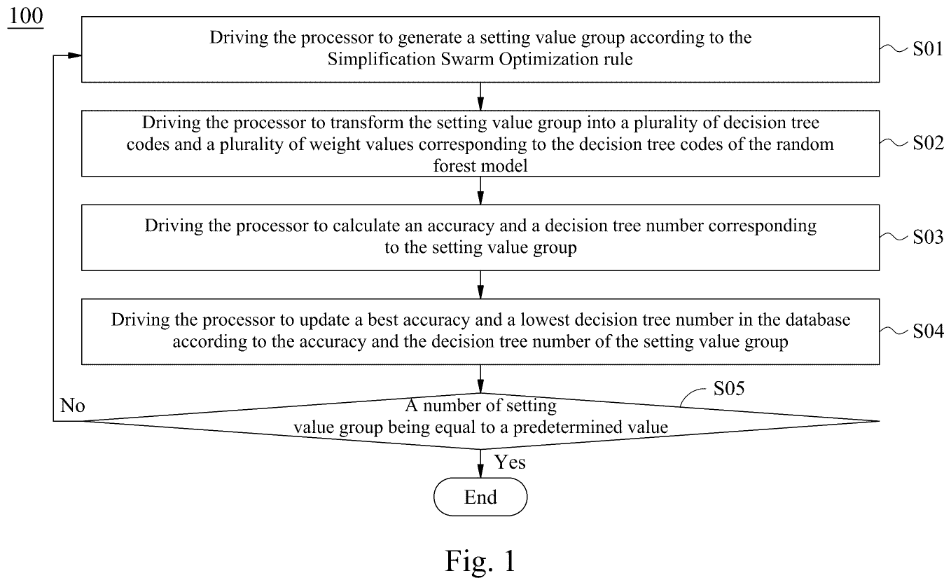

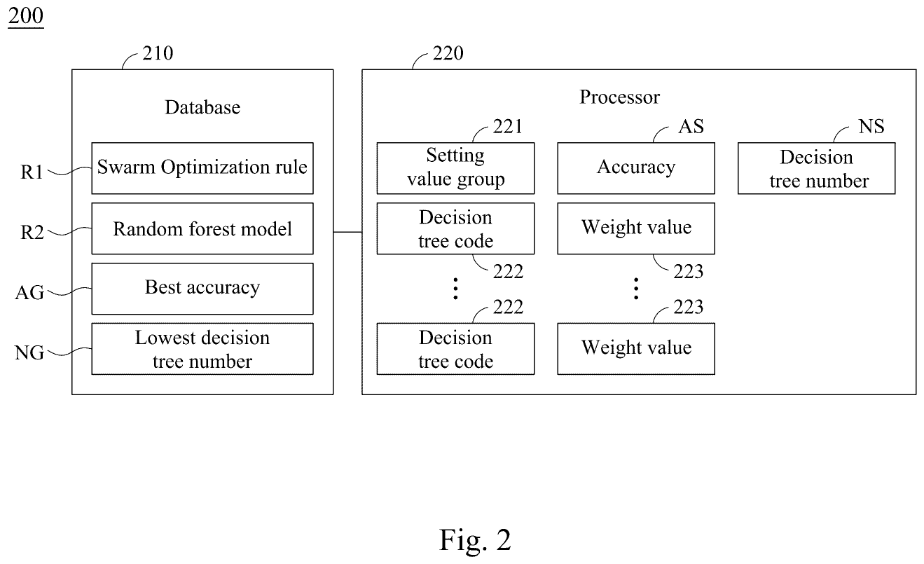

Please refer to FIG. 1 and FIG. 2. FIG. 1 shows a flow chart of a random forest optimization method 100 according to a first embodiment of the present disclosure. FIG. 2 shows a block diagram of a random forest optimization system 200 according to a second embodiment of the present disclosure. In FIG. 2, the random forest optimization system 200 includes a database 210 and a processor 220. The database 210 includes a Simplification Swarm Optimization rule R1, a random forest model R2, a best accuracy AG and a lowest decision tree number NG. The processor 220 is signally connected to the database 210, and configured to perform a random forest optimization method 100 in FIG. 1, but the present disclosure is not limited thereto. Specifically, the random forest optimization method 100 includes steps S01, S02, S03, S04, S05. The step S01 includes driving the processor 220 to generate a setting value group 221 according to the Simplification Swarm Optimization rule R1. The step S02 includes driving the processor 220 to transform the setting value group 221 into a plurality of decision tree codes 222 and a plurality of weight values 223 corresponding to the decision tree codes 222 of the random forest model R2. The decision tree codes 222 correspond to a plurality of binary decision tree models. The step S03 includes driving the processor 220 to calculate an accuracy AS and a decision tree number NS corresponding to the setting value group 221. The accuracy AS is a predicting accuracy of the random forest model R2, and the decision tree number NS is a number of the binary decision tree models. The step S04 includes driving the processor 220 to update a best accuracy AG and a lowest decision tree number NG in the database 210 according to the accuracy AS and the decision tree number NS of the setting value group 221. The step S05 includes driving the processor 220 to repeating the steps S01, S02, S03, S04 until a number of a plurality of the setting value groups 221 being equal to a predetermined value.

In detail, the database 210 includes a Random Access Memory (RAM) capable to store information and instruction for the processor 220 to process or other dynamic storing device, the processor 220 can include any type of processor, microprocessor, but the present disclosure is not limited thereto. The random forest model R2 includes a plurality of binary decision tree models. Each of the binary decision tree models includes at least one node and two branches connected to the at least one node. Each of the binary decision tree models corresponds to one of the weight values 223. In the first embodiment, the processor 220 is installed a 64-bit Windows 10 operating system and run on open-source software Python and Scikit Learn package to perform the random forest model R2. The database 210 is a 16 GB RAM, and the present disclosure is not limited thereto.

The Simplification Swarm Optimization rule R1 is configured to generate a setting value group 221 of the present iteration, and the setting value group 221 includes a plurality of setting values. The Simplification Swarm Optimization rule R1 is satisfied the following formula (1):

$${x}_{i , j} = \{ \begin{matrix}{g}_{j} , & if {ρ}_{[ 0 , 1 ]} ∈ [ 0 , {C}_{g} ) \\ {p}_{i , j} , & if {ρ}_{[ 0 , 1 ]} ∈ [ {C}_{g} , {C}_{p} ) \\ {x}_{i , j} , & if {ρ}_{[ 0 , 1 ]} ∈ [ {C}_{p} , {C}_{w} ) \\ x , & if {ρ}_{[ 0 , 1 ]} ∈ [ {C}_{w} , 1 ]\end{matrix} . \qquad ( 1 )$$

x_{i,j} is a j-th setting value of an i-th setting value group, gⱼ is a j-th setting value of a global best setting value group, p_{i,j} is a j-th setting value of a partial best setting value group, x is a random value, p is a random parameter between 0 and 1, C_{g}, Cₚ, C_{w} represent a first parameter, a second parameter and a third parameter, respectively. Take Table 1 as an example, i is 2, x_{2,j} represents the setting value group 221 presently generated is the j-th setting value of the second setting value group 221 in the present iteration. The first parameter C_{g} is 0.4, the second parameter Cₚ is 0.7, and the third parameter C_{w} is 0.9. The present setting value group 221 is (3.5, 4.3, 4.5, 3.1, 6.9), the random parameter pⱼ is (0.35, 0.91, 0.82, 0.44, 0.17). The partial best setting value group p_{2,j} in the present iteration is (5.7, 6.8, 6.7, 5.2, 2.5). The global best setting value group gⱼ is (2.2, 3.5, 7.1, 4.3, 5.5). The Simplification Swarm Optimization rule R1 updates the setting value in the setting value group 221 according to a value relationship between the random parameter ρⱼ and the first parameter, the second parameter and the third parameter. In the Table 1, the first random parameter ρ₁ is 0.35, and is smaller than the first parameter, that is, the updated setting value x_{2,1} is the first value 2.2 in the global best setting value group. The second random parameter ρ₂ is 0.91, and is bigger than the third parameter, that is, the updated setting value x_{2,2} is a random value 5.6. The third random parameter ρ₃ is 0.82, and is between the second parameter and the third parameter, that is, the updated setting value x_{2,3} is a third value 4.5 in the second setting value group 221 of the present iteration. The fourth random parameter ρ₄ is 0.44, and is between the first parameter and the second parameter, that is, the updated setting value x_{2,4} is the fourth setting value 5.2 in the partial best setting value group p_{2,j}. The fifth random parameter ρ₅ is 0.17, and is smaller than the first parameter, that is, the updated setting value x_{2,5} is the fifth setting value 5.5 in the global best setting value group.

TABLE 1

| j | 1 | 2 | 3 | 4 | 5 |
|---|---|---|---|---|---|
| x_{2, j} | 3.5 | 4.3 | 4.5 | 3.1 | 6.9 |
| p_{2, j} | 5.7 | 6.8 | 6.7 | 5.2 | 2.5 |
| gⱼ | 2.2 | 3.5 | 7.1 | 4.3 | 5.5 |
| ρⱼ | 0.35 | 0.91 | 0.82 | 0.44 | 0.17 |
| interval | ρ₁ < C_{g} | C_{w} < ρ₂ | Cₚ < ρ₃ < C_{w} | C_{g} < ρ₄ < Cₚ | ρ₅ < C_{g} |
| updated x_{2, j} | 2.2 | 5.6 | 4.5 | 5.2 | 5.5 |

Moreover, each of the setting values in the setting value group 221 includes a floating part, and the integer part and the floating part correspond to the n-th binary decision tree model and the weight value of the n-th binary decision tree model, respectively. For example, when a setting value group 221 is (7.5, 4.4, 6.6, 7.7, 10.4), the fifth setting value 10.4 can be divided to “10” and “0.4”, and represents the weight value of the 10th binary decision tree model is 0.4. Further, the integer parts of the first setting value and the fourth setting value are both 7, that is, the weight value 223 of the seventh binary decision tree model is the floating part of the first setting value plus the floating part of the fourth setting value (i.e., 1.5).

The step S03 is performed to set the number, the decision tree code 222 and the weight value 223 of the decision tree, specified by the setting value group 221, to the random forest model R2, predict a predicting result of a dataset through the random forest model R2, and calculate the accuracy AS and the decision tree number NS of the present random forest model R2.

The step S04 is performed to compare the accuracy AS and the decision tree number NS of the setting value group 221 presently generated with the best accuracy AG and the lowest decision tree number NG, which is record previously, in the database 210. When the accuracy AS and the decision tree number NS of the random forest model R2 corresponding to the setting value group 221 is better than the best accuracy AG and the lowest decision tree number NG, the accuracy AS and the decision tree number NS of the random forest model R2 replace the best accuracy AG and the lowest decision tree number NG to store into the database 210.

The step S05 is performed to execute the steps S01-S04 repeatedly, to generate the next setting value group 221, set the parameter in the aforementioned setting value group 221 to the random forest model R2, and verify the accuracy AS of the random forest model R2, update the best accuracy AG and the lowest decision tree number NG in the database 210, until the predetermined number of iterations is achieved. Thus, the random forest optimization method 100 and the random forest optimization system 200 of the present disclosure can reduce the decision tree number NS of the random forest model R2, and reduce the computing time of the model being predicting effectively. The step S04 is described in more detail below.

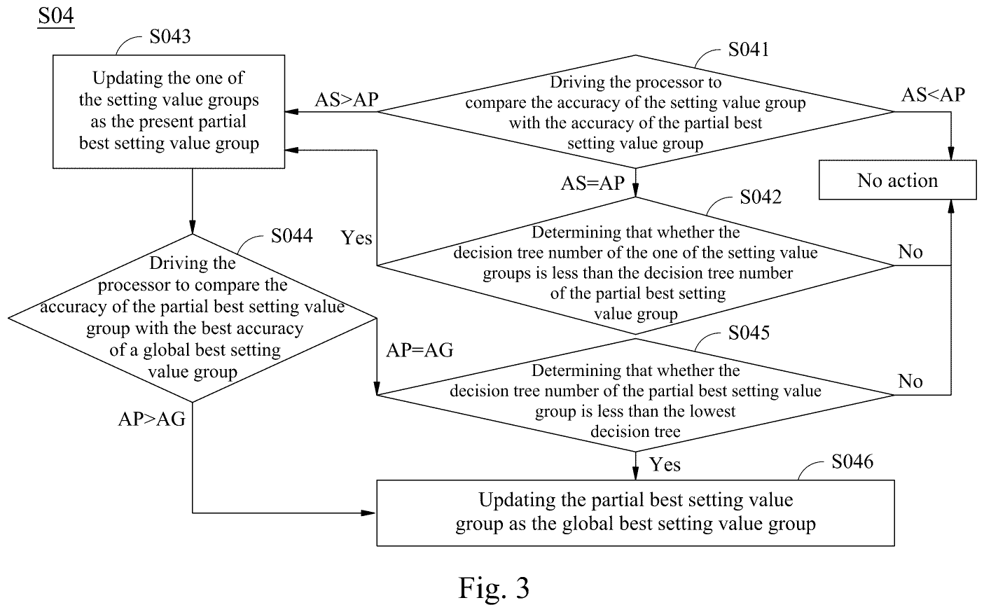

Please refer to FIG. 2 to FIG. 3. FIG. 3 shows a schematic view of updating the best accuracy AG and the lowest decision tree number NG of the random forest optimization method 100 of FIG. 1. The step S04 can include steps S041, S042, S043, S044, S045, S046.

The step S041 includes driving the processor 220 to compare the accuracy AS of the setting value group 221 with the accuracy AP of the partial best setting value group. The partial best setting value group is a best one of the setting value groups 221 in a present iteration. In response to determining that the accuracy AS of one of the setting value groups 221 is greater than the accuracy AP of the partial best setting value group (i.e., “AS>AP”), the step S043 is executed. In response to determining that the accuracy AS of the one of the setting value groups 221 is equal to the accuracy AP of the partial best setting value group (i.e., “AS=AP”), the step S042 is executed. The step S042 includes determining that whether the decision tree number NS of the one of the setting value groups 221 is less than the decision tree number of the partial best setting value group. When the decision tree number NS of the setting value group 221 is less than the decision tree number of the partial best setting value group, the step S043 is performed. The step S043 includes updating the one of the setting value groups 221 as the present partial best setting value group. The step S044 includes driving the processor 220 to compare the accuracy AP of the partial best setting value group with the best accuracy AG of a global best setting value group. The global best setting value group is a best one of the setting value groups, and the global best setting value group has the best accuracy AG and the lowest decision tree number NG. In response to determining that the accuracy AP of the partial best setting value group is greater than the best accuracy AG of the global best setting value group (i.e., “AP>AG”), the step S046 is performed. In response to determining that the accuracy AP of the partial best setting value group is equal to the best accuracy AG of the global best setting value group (i.e., “AP=AG”), the step S045 is performed. The step S045 includes determining that whether the decision tree number of the partial best setting value group is less than the lowest decision tree number NG, when the partial best setting value group is less than the lowest decision tree number NG, the step S046 is performed. The step S046 includes updating the partial best setting value group as the global best setting value group.

In other words, if the accuracy AS of the present setting value group 221 is greater than the accuracy AP of the partial best setting value group, the present setting value group 221 can replace the previous partial best setting value group to be the new partial best setting value group. Moreover, if the accuracy AS of the present setting value group 221 is the same as the accuracy AP of the partial best setting value group, and the decision tree number NS of the present setting value group 221 is less than the partial best setting value group, the present setting value group 221 can also replace the previous partial best setting value group to be the new partial best setting value group.

Further, if the accuracy AP of the partial best setting value group is greater than the best accuracy AG, the partial best setting value group can replace the previous global best setting value group to be the new global best setting value group. Furthermore, if the accuracy AP of the partial best setting value group is equal to the best accuracy AG of the global best setting value group, and the decision tree number of the partial best setting value group is less than the lowest decision tree number NG, the partial best setting value group can replace the previous global best setting value group to be the new global best setting value group.

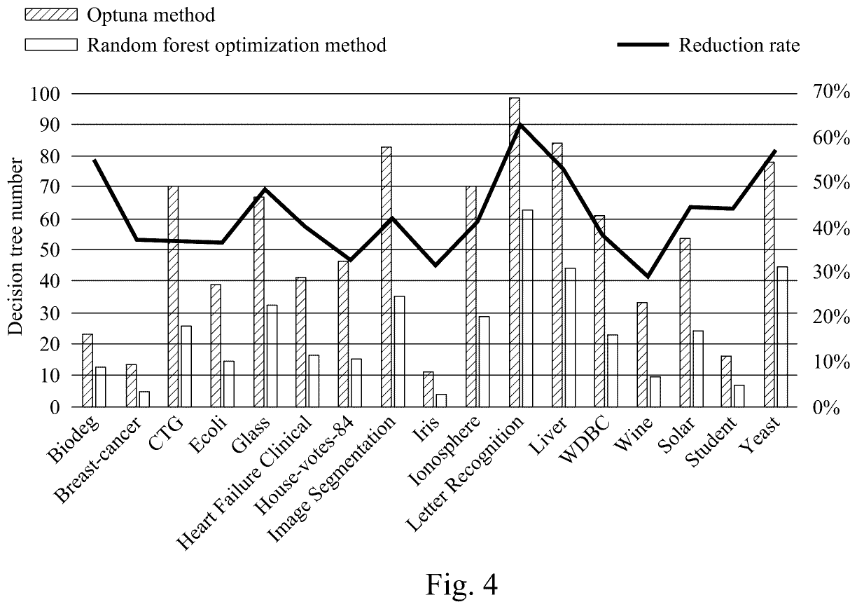

Please refer to FIG. 2 to FIG. 4. FIG. 4 shows a comparative schematic view between the decision tree number of the random forest optimization method 100 of FIG. 1 and a decision tree number of a conventional Optuna method. In FIG. 4, the decision tree numbers and the reduction rates of the random forest optimization method 100 of the present disclosure and the conventional Optuna method, which are applied on 17 datasets of a machine learning database of UCI. The 17 datasets includes Biodeg, Breast-cancer, CTG, Ecoli, Glass, Heart Failure Clinical, House-votes-84, Image Segmentation, Iris, Ionosphere, Letter Recognition, Liver, WDBC, Wine, Solar, Student and Yeast. The decision tree number of the random forest optimization method 100 of the present disclosure shown in FIG. 4 is an average value of the decision tree number.

Please refer to Table 2 and Table 3, Table 2 lists the number of the data and a number of the feature in each of the data of the aforementioned 17 datasets and the model depth of the random forest model optimized by conventional Optuna method. Table 3 lists the decision tree number of the random forest model of the random forest model optimized by conventional Optuna method and the average value of the decision tree number of the random forest optimization method 100 of the present disclosure. In Table 2 and Table 3, the dataset with more data amount has more decision trees. Due to the decision tree number is relative to the time complexity, the accuracy and the run time of model calculating, the impact magnitude may be obvious when the dataset is huger. Thus, the random forest optimization method 100 of the present disclosure can increase more accuracy of the predicting result of the random forest than the conventional Optuna method under the condition that the decision tree number is reduced.

TABLE 2

| | | number of | |
|---|---|---|---|
| dataset | number of data | feature | model depth |
| Biodeg | 1055 | 41 | 10 |
| Breast-cancer | 286 | 9 | 6 |
| CTG | 2126 | 41 | 9 |
| Ecoli | 336 | 7 | 6 |
| Glass | 214 | 9 | 10 |
| Heart Failure Clinical | 299 | 12 | 10 |
| House-votes-84 | 435 | 16 | 9 |
| Image Segmentation | 210 | 19 | 7 |
| Iris | 150 | 4 | 9 |
| Ionosphere | 351 | 33 | 7 |
| Letter Recognition | 20000 | 16 | 10 |
| Liver | 345 | 6 | 5 |
| WDBC | 569 | 31 | 10 |
| Wine | 178 | 13 | 6 |
| Solar | 208 | 60 | 9 |
| Student | 145 | 31 | 9 |
| Yeast | 1484 | 9 | 10 |

TABLE 3

| | decision tree number | decision tree number |
|---|---|---|
| dataset | (Optuna method) | (the present disclosure) |
| Biodeg | 23 | 12.67 |
| Breast-cancer | 13 | 4.83 |
| CTG | 70 | 25.7 |
| Ecoli | 39 | 14.27 |
| Glass | 67 | 32.5 |
| Heart Failure Clinical | 41 | 16.23 |
| House-votes-84 | 46 | 15.07 |
| Image Segmentation | 83 | 34.93 |
| Iris | 11 | 3.47 |
| Ionosphere | 70 | 29.0 |
| Letter Recognition | 99 | 62.53 |
| Liver | 84 | 53.1 |
| WDBC | 61 | 37.5 |
| Wine | 33 | 28.9 |
| Solar | 54 | 44.6 |
| Student | 16 | 44.2 |
| Yeast | 78 | 57.3 |

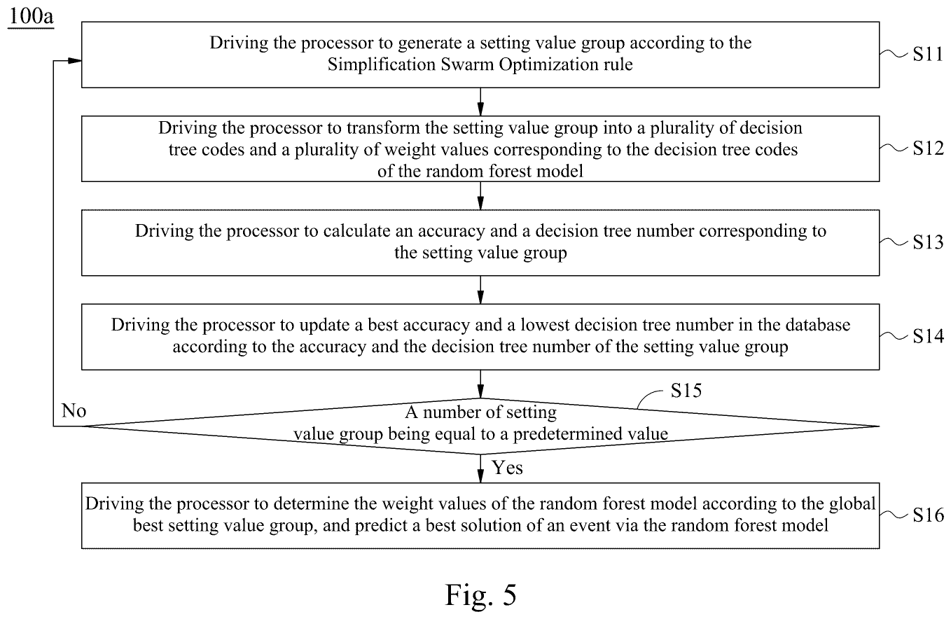

Please refer to FIG. 1, FIG. 2 and FIG. 5. FIG. 5 shows a flow chart of a random forest optimization method 100a according to a third embodiment of the present disclosure. The random forest optimization method 100a includes steps S11, S12, S13, S14, S15, S16. In the third embodiment, the steps S11, S12, S13, S14, S15 can be the same as the steps S01, S02, S03, S04, S05 of the random forest optimization method 100 of the first embodiment, and will not be described again. In FIG. 5, the random forest optimization method 100a further includes the step S16. The step S16 includes driving the processor 220 to determine the weight values 223 of the random forest model R2 according to the global best setting value group, and predict a best solution of an event via the random forest model R2.

For instance, the random forest optimization method 100a can be applied to disease prediction, path prediction of intelligent probe card or probability of other event, but the present disclosure is not limited thereto. Moreover, by calculating the best decision tree code 222 and the corresponding weight value 223 of the random forest model R2 through the steps S11-S15, and set the decision tree code 222 and the corresponding weight value 223 of the global best setting value group to the random forest model R2 and the related parameter dataset are inputted into the random forest model R2 to predict the disease occurred probability or the best moving path through the step S16. Furthermore, the random forest optimization method 100a can further display the predicting result of the disease occurred probability or the best moving path to a decision maker via a display, and the decision maker can adjust or verify the medical decision according to the disease occurred probability or perform the product testing, product assembling according to the predicted best path of the machine to improve the efficiency of the production line.

A computer readable recording medium storing a program for a processor 220 to execute the random forest optimization methods 100, 100a. The computer readable recording medium can be a CR-ROM, a flexible disk (FD), a CD-R, a digital versatile disk (DVD), a USB medium and a flash memory, but the present disclosure is not limited thereto.

According to the aforementioned embodiments and examples, the advantages of the present disclosure are described as follows.
1. The random forest optimization system of the present disclosure can reduce the decision tree number of the random forest model, and reduce the computing time of the model being predicting effectively.
2. The random forest optimization method of the present disclosure can increase more accuracy of the predicting result of the random forest than the conventional Optuna method under the condition that the decision tree number is reduced.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A random forest optimization method, comprising:
driving a processor to generate a setting value group according to a Simplification Swarm Optimization rule;
driving the processor to transform the setting value group into a plurality of decision tree codes and a plurality of weight values corresponding to the decision tree codes of a random forest model, wherein the decision tree codes correspond to a plurality of binary decision tree models;
driving the processor to calculate an accuracy and a decision tree number corresponding to the setting value group, wherein the accuracy is a predicting accuracy of the random forest model, and the decision tree number is a number of the binary decision tree models;
driving the processor to update a best accuracy and a lowest decision tree number in a database according to the accuracy and the decision tree number of the setting value group; and
driving the processor to repeating the above steps until a number of a plurality of the setting value groups being equal to a predetermined value.

2. The random forest optimization method of claim 1, wherein each of the binary decision tree models comprises at least one node and two branches connected to the at least one node, and the binary decision tree models correspond to the weight values.

3. The random forest optimization method of claim 1, wherein the Simplification Swarm Optimization rule is satisfied the following condition:
$${x}_{i , j} = \{ \begin{matrix}{g}_{j} , & if {ρ}_{[ 0 , 1 ]} ∈ [ 0 , {C}_{g} ) \\ {p}_{i , j} , & if {ρ}_{[ 0 , 1 ]} ∈ [ {C}_{g} , {C}_{p} ) \\ {x}_{i , j} , & if {ρ}_{[ 0 , 1 ]} ∈ [ {C}_{p} , {C}_{w} ) \\ x , & if {ρ}_{[ 0 , 1 ]} ∈ [ {C}_{w} , 1 ]\end{matrix} ;$$
wherein x_{i,j} is a j-th setting value of an i-th setting value group, gⱼ is a j-th setting value of a global best setting value group, p_{i,j} is a j-th setting value of a partial best setting value group, x is a random value, p is a random parameter between 0 and 1, C_{g}, Cₚ, C_{w} are a first parameter, a second parameter and a third parameter, respectively.

4. The random forest optimization method of claim 1, wherein,
driving the processor to compare the accuracy of the setting value group with the accuracy of a partial best setting value group, wherein the partial best setting value group is a best one of the setting value groups in a present iteration;
wherein in response to determining that the accuracy of one of the setting value groups is greater than the accuracy of the partial best setting value group; or
in response to determining that the accuracy of the one of the setting value groups is equal to the accuracy of the partial best setting value group, and the decision tree number of the one of the setting value groups is less than the decision tree number of the partial best setting value group, the one of the setting value groups is updated as the partial best setting value group; and
driving the processor to compare the accuracy of the partial best setting value group with the best accuracy of a global best setting value group, wherein the global best setting value group is a best one of the setting value groups, and the global best setting value group has the best accuracy and the lowest decision tree number;
wherein in response to determining that the accuracy of the partial best setting value group is greater than the best accuracy of the global best setting value group; or
in response to determining that the accuracy of the partial best setting value group is equal to the best accuracy of the global best setting value group, and the decision tree number of the partial best setting value group is less than the lowest decision tree number, the partial best setting value group is updated as the global best setting value group.

5. The random forest optimization method of claim 4, further comprising:
driving the processor to determine the weight values of the random forest model according to the global best setting value group, and predict a best solution of an event via the random forest model.

6. A random forest optimization system, comprising:
a database comprising a Simplification Swarm Optimization rule, a random forest model, a best accuracy and a lowest decision tree number; and
a processor signally connected to the database, and configured to perform a random forest optimization method comprising:
generating a setting value group according to the Simplification Swarm Optimization rule;
transforming the setting value group into a plurality of decision tree codes and a plurality of weight values corresponding to the decision tree codes of the random forest model, wherein the decision tree codes correspond to a plurality of binary decision tree models;
calculating an accuracy and a decision tree number corresponding to the setting value group, wherein the accuracy is a predicting accuracy of the random forest model, and the decision tree number is a number of the binary decision tree models;
updating the best accuracy and the lowest decision tree number according to the accuracy and the decision tree number of the setting value group; and
repeating the above steps until a number of a plurality of the setting value groups being equal to a predetermined value.

7. The random forest optimization system of claim 6, wherein each of the binary decision tree models comprises at least one node and two branches connected to the at least one node, and the binary decision tree models correspond to the weight values.

8. The random forest optimization system of claim 6, wherein the Simplification Swarm Optimization rule is satisfied the following condition:
$${x}_{i , j} = \{ \begin{matrix}{g}_{j} , & if {ρ}_{[ 0 , 1 ]} ∈ [ 0 , {C}_{g} ) \\ {p}_{i , j} , & if {ρ}_{[ 0 , 1 ]} ∈ [ {C}_{g} , {C}_{p} ) \\ {x}_{i , j} , & if {ρ}_{[ 0 , 1 ]} ∈ [ {C}_{p} , {C}_{w} ) \\ x , & if {ρ}_{[ 0 , 1 ]} ∈ [ {C}_{w} , 1 ]\end{matrix} ;$$
wherein x_{i,j} is a j-th setting value of an i-th setting value group, gⱼ is a j-th setting value of a global best setting value group, p_{i,j} is a j-th setting value of a partial best setting value group, x is a random value, p is a random parameter between 0 and 1, C_{g}, Cₚ, C_{w} are a first parameter, a second parameter and a third parameter, respectively.

9. The random forest optimization system of claim 6, wherein,
comparing the accuracy of the setting value group with the accuracy of a partial best setting value group, wherein the partial best setting value group is a best one of the setting value groups in a present iteration;
wherein in response to determining that the accuracy of one of the setting value groups is greater than the accuracy of the partial best setting value group; or
in response to determining that the accuracy of the one of the setting value groups is equal to the accuracy of the partial best setting value group, and the decision tree number of the one of the setting value groups is less than the decision tree number of the partial best setting value group, the one of the setting value groups is updated as the partial best setting value group; and
comparing the accuracy of the partial best setting value group with the best accuracy of a global best setting value group, wherein the global best setting value group is a best one of the setting value groups, and the global best setting value group has the best accuracy and the lowest decision tree number;
wherein in response to determining that the accuracy of the partial best setting value group is greater than the best accuracy of the global best setting value group; or
in response to determining that the accuracy of the partial best setting value group is equal to the best accuracy of the global best setting value group, and the decision tree number of the partial best setting value group is less than the lowest decision tree number, the partial best setting value group is updated as the global best setting value group.

10. The random forest optimization system of claim 9, wherein the random forest optimization method further comprises:
determining the weight values of the random forest model according to the global best setting value group, and predict a best solution of an event via the random forest model.

11. A computer readable recording medium storing a program for a processor to execute a random forest optimization method comprising:
driving the processor to generate a setting value group according to a Simplification Swarm Optimization rule;
driving the processor to transform the setting value group into a plurality of decision tree codes and a plurality of weight values corresponding to the decision tree codes of a random forest model, wherein the decision tree codes correspond to a plurality of binary decision tree models;
driving the processor to calculate an accuracy and a decision tree number corresponding to the setting value group, wherein the accuracy is a predicting accuracy of the random forest model, and the decision tree number is a number of the binary decision tree models;
driving the processor to update a best accuracy and a lowest decision tree number in a database according to the accuracy and the decision tree number of the setting value group; and
driving the processor to repeating the above steps until a number of a plurality of the setting value groups being equal to a predetermined value.

12. The computer readable recording medium of claim 11, wherein each of the binary decision tree models comprises at least one node and two branches connected to the at least one node, and the binary decision tree models correspond to the weight values.

13. The computer readable recording medium of claim 11, wherein the Simplification Swarm Optimization rule is satisfied the following condition:
$${x}_{i , j} = \{ \begin{matrix}{g}_{j} , & if {ρ}_{[ 0 , 1 ]} ∈ [ 0 , {C}_{g} ) \\ {p}_{i , j} , & if {ρ}_{[ 0 , 1 ]} ∈ [ {C}_{g} , {C}_{p} ) \\ {x}_{i , j} , & if {ρ}_{[ 0 , 1 ]} ∈ [ {C}_{p} , {C}_{w} ) \\ x , & if {ρ}_{[ 0 , 1 ]} ∈ [ {C}_{w} , 1 ]\end{matrix} ;$$
wherein x_{i,j} is a j-th setting value of an i-th setting value group, gⱼ is a j-th setting value of a global best setting value group, p_{i,j} is a j-th setting value of a partial best setting value group, x is a random value, p is a random parameter between 0 and 1, C_{g}, Cₚ, C_{w} are a first parameter, a second parameter and a third parameter, respectively.

14. The computer readable recording medium of claim 11, wherein,
driving the processor to compare the accuracy of the setting value group with the accuracy of a partial best setting value group, wherein the partial best setting value group is a best one of the setting value groups in a present iteration;
wherein in response to determining that the accuracy of one of the setting value groups is greater than the accuracy of the partial best setting value group; or
in response to determining that the accuracy of the one of the setting value groups is equal to the accuracy of the partial best setting value group, and the decision tree number of the one of the setting value groups is less than the decision tree number of the partial best setting value group, the one of the setting value groups is updated as the partial best setting value group; and
driving the processor to compare the accuracy of the partial best setting value group with the best accuracy of a global best setting value group, wherein the global best setting value group is a best one of the setting value groups, and the global best setting value group has the best accuracy and the lowest decision tree number;
wherein in response to determining that the accuracy of the partial best setting value group is greater than the best accuracy of the global best setting value group; or
in response to determining that the accuracy of the partial best setting value group is equal to the best accuracy of the global best setting value group, and the decision tree number of the partial best setting value group is less than the lowest decision tree number, the partial best setting value group is updated as the global best setting value group.

15. The computer readable recording medium of claim 14, wherein the random forest optimization method further comprises:
driving the processor to determine the weight values of the random forest model according to the global best setting value group, and predict a best solution of an event via the random forest model.
